(19) United States
(12) Patent Application Publication
(10) Pub. No.: US 2006/0114591 A1
(43) Pub. Date: Jun. 1, 2006

(54) Magnetic recording method

(75) Inventors: Jun Taguchi, Kawasaki (JP); Shingo Hamaguchi, Kawasaki (JP); Koji Matsumoto, Kawasaki (JP)

Correspondence Address: Patrick G. Burns, Esq.;GREEN, BURNS & CRAIN, LTD., Suite 2500, 300 South Wacker Dr., Chicago, IL, 60606, US

(73) Assignee: FUJITSU LIMITED

(21) Appl. No.: 11/289,742

(22) Filed: Nov. 29, 2005

(30) Foreign Application Priority Data
Nov. 29, 2004 (JP) 2004-344424

(51) Int. Cl. G11B 5/02

(52) U.S. Cl. 360/59

(57) ABSTRACT

A magnetic recording method is provided for a magnetic recording medium including a magnetic recording layer. In accordance with the method, a recording magnetic field is applied to a local region in the recording layer to form a recording mark in the recording layer. Then, another recording magnetic field is applied to another local region in the recording layer to form another recording mark in the recording layer. Each of the recording magnetic fields is adjusted in strength in accordance with the length of the recording mark to be formed in the recording layer. The adjusted recording magnetic field is applied locally to the recording layer.

### BACKGROUND OF THE INVENTION

1. Field of the Invention

The present invention relates to a method of executing recording of information for a magnetic recording medium including a magnetic recording layer.

2. Description of the Related Art

As known in the art, magnetic recording mediums (magnetic disks) are used for data storage apparatus such as hard disk units. The demand for greater recording density of magnetic disks has been increasing with the increase in the amount of information processed in computer systems.

To write information to a magnetic disk, the magnetic recording head is positioned in close proximity to the magnetic recording layer of the magnetic disk, and a magnetic field stronger than the magnetic coercive force is applied to the magnetic recording layer by the magnetic head. By moving the magnetic head in relation to the magnetic disk to sequentially reverse the orientation of the recording magnetic field from the magnetic head, a plurality of magnetic domains (recording marks), in which the orientation of magnetization is sequentially reversed, are formed joined from the circumferential direction of the magnetic disk towards the direction of extension of the tracks. By controlling the timing with which the orientation of the recording magnetic field is changed, recording marks are each formed with the prescribed length. Thus, the prescribed signal and information is recorded as changes in the magnetic orientation in the magnetic recording layer.

In the technical field of the magnetic disk, it is known that the thermal stability of the magnetic domains formed in the magnetic recording layer is enhanced as the magnetic coercive force of the magnetic recording layer becomes stronger, whereby stable microscopic magnetic domains can be readily formed. In the magnetic recording layer, smaller magnetic sectors are preferable for attaining a greater recording density of the magnetic disk.

In recording information on the magnetic disk, the recording mark cannot be formed properly unless the applied recording magnetic field is stronger than the magnetic coercive force of the magnetic recording layer. Thus, it is one conceivable way to increase the strength of the recording magnetic field applied by the magnetic head in accordance with increasing the magnetic coercive force set for the magnetic recording layer. However, the strength of the recording magnetic field applied by the magnetic head is, for example, restricted by the structure and power consumption of the magnetic head.

In light of the above, the so-called ‘thermally-assisted’ magnetic recording method may be adopted for recording information on magnetic disks. To record information on magnetic disks with the thermally-assisted method, a prescribed local area of the magnetic recording layer is first heated by laser illumination from an optical head. Thus, the magnetic coercive force of the heated area of the magnetic recording layer is reduced in comparison to that of the surrounding non-heated area. Next, a recording magnetic field stronger than the magnetic coercive force of the heated area is applied to the heated area by the magnetic head to magnetize part of the heated area in the prescribed orientation. This magnetization can be fixed by cooling the magnetized location, and a recording mark magnetized in the prescribed orientation is formed.

According to the thermally-assisted magnetic recording method, information is recorded by application of a recording magnetic field to locations at which the magnetic coercive force has been weakened by heating. Thus, even if the magnetic coercive force of the magnetic recording layer is set to a high value so that information is retained or played back at ambient temperature, excessive increase in the strength of the recording magnetic field from the magnetic head is unnecessary. This thermally-assisted magnetic recording method is disclosed in, for example, Japanese Patent Application Laid-open No. H6-243527 and Japanese Patent Application Laid-open No. 2003-157502.

On the other hand, in the technical field of the magnetic disk, it is known that the effective magnetic coercive force of the magnetic recording layer will change in accordance with a period of time (recording time) for which the external magnetic field from the magnetic head is applied. Further, it is known that the change of the magnetic coercive force is described by equation (1) below. FIG. 1 is a graph showing an example of the dependence of magnetic coercive force on recording time according to equation (1). In equation (1), Hc is the magnetic coercive force (Oe) of the location at which the magnetic field is applied, Hc₀ is the theoretical magnetic coercive force (Oe) of the location at which the magnetic field is applied at a recording time of 0 seconds, k_{B} is Boltzmann's constant (1.38×10⁻²³ J/deg), T is the ambient temperature (K), Ku is the magnetic anisotropy constant (erg/cm³) of the magnetic recording layer, V is the volume (cm³) of the magnetic body (recording mark), τ₀ is the relaxation constant (=1.0×10⁻⁹ seconds), and t is the recording time (seconds). Furthermore, in the graph in FIG. 1, the recording time t (seconds) is shown on the horizontal axis, and the magnetic coercive force Hc (Oe) of the magnetic recording layer is shown on the vertical axis, and the solid line represents the dependence of the magnetic coercive force Hc on recording time.

$$Hc = {Hc}_{0} \{ 1 - {[ \frac{{k}_{B} T}{KuV} ln ( \frac{t}{{τ}_{0} ln 2} ) ]}^{\frac{2}{3}} \} \qquad ( 1 )$$

In equation (1) and the graph in FIG. 1, if the magnetic coercive force Hc when the recording time t is the prescribed recording time t₁ is Hc1, and the magnetic coercive force Hc when the recording time t is the prescribed recording time t₂ (<t₁) is Hc₂, Hc₁<Hc₂ as shown in the graph in FIG. 1. In other words, if the time for which the external magnetic field is applied to the magnetic recording layer by the magnetic head (recording time t) differs, the effective magnetic coercive force Hc at the location at which the magnetic field is applied differs, and the shorter the recording time t, the larger the magnetic coercive force Hc. The shorter the recording time t, the stronger the minimum external magnetic field for forming the recording mark on the magnetic recording layer.

Generally, in a magnetic recording method for magnetic disks, recording marks of eight different lengths are set. These recording marks are formed in a magnetic recording layer as magnetic domains in which the orientation of magnetization is sequentially reversed correspondingly to the recorded information. For a longer recording mark, the application time of the recording magnetic field to the magnetic recording layer (i.e., recording time to form a single recording mark) tends to become longer. As described above, the shorter the recording time, the greater the effective magnetic coercive force in the magnetic recording layer, and the stronger the minimum external magnetic field to form the recording mark on the magnetic recording layer. In the conventional magnetic recording method, the magnetic field of a constant strength for forming the shortest recording mark is to be applied to the magnetic recording layer in forming any one of the eight recording marks.

With the conventional magnetic recording method described above, however, the recording magnetic field for forming the shortest recording mark is too strong for forming the other kinds of recording marks (recording marks for which the length and recording time are longer), there may be a problem.

Specifically, in forming a recording mark other than the shortest recording mark, the recording magnetic field applied to the magnetic recording layer is too strong for forming the target recording mark. Thus, the so-called recording demagnetization phenomenon may occur, in which the recording mark formed immediately previously is lost or degraded. The recording demagnetization phenomenon reduces the SNR (Signal-to-Noise Ratio) of the playback signal during playback of the information on the magnetic disk, inhibiting an increase in recording density of the magnetic disk, and is therefore not desirable. Furthermore, since the recording magnetic field applied to the magnetic recording layer is too strong, the resulting recording mark formed may have an unsuitable width. The unsuitable increase in width of the recording mark is not desirable in terms of narrowed track pitch, and thus is not desirable in terms of increasing recording density of the magnetic disk.

### DISCLOSURE OF THE INVENTION

With the foregoing in view, it is an object of the present invention to provide a magnetic recording method suitable for increased recording density of magnetic recording mediums such as magnetic disks.

According to the first aspect of the present invention, a method of recording information on a magnetic recording medium including a magnetic recording layer is provided. With this method, a recording magnetic field is applied to a local region in the recording layer to form a recording mark in the recording layer, and another recording magnetic field is applied to another local region in the recording layer to form another recording mark in the recording layer. Each of the recording magnetic field is adjusted in strength in accordance with the length of the recording mark to be formed in the recording layer. Then, the adjusted recording magnetic field is applied locally to the recording layer.

As described in reference to FIG. 1, when the time for which the recording magnetic field is applied (recording time) to the magnetic recording layer by the magnetic head differs, the effective magnetic coercive force at the location of application of the magnetic field differs, and the shorter the recording time the greater the magnetic coercive force. When information is recorded on the magnetic recording medium with the magnetic recording method of the first aspect of the present invention, a suitable magnetic recording strength equal to or greater than the effective magnetic coercive force at the location of application on the magnetic recording layer, and such that the afore-mentioned recording demagnetization phenomenon and unsuitable increase in width of the recording mark are sufficiently suppressed, is selected according to the length of the recording mark to be formed (in other words, according to recording time), and a magnetic field of the strength for the mark to be formed can be applied to the magnetic recording layer. According to the present magnetic recording method, therefore, the recording mark can be appropriately formed while the recording demagnetization phenomenon and unsuitable enlargement of the recording mark is suppressed. Such a magnetic recording method is suitable for increased recording density of magnetic recording mediums.

According to the second aspect of the present invention, another method of executing recording of information on a magnetic recording medium including a magnetic recording layer is provided. With this method, a local region in the recording layer is irradiated with a laser beam so that it is heated. Then, a recording magnetic field is applied to the heated local region to form a recording mark in the recording layer. The recording magnetic field is adjusted in strength in accordance with the length of the recording mark to be formed in the recording layer. Then, the adjusted recording magnetic field is applied locally to the heated local region.

With the thermally-assisted magnetic recording method of the second aspect of the present invention, when a suitable magnetic recording strength is selected according to the length of the recording mark to be formed (in other words, according to recording time) when information is recorded on the magnetic recording medium, a magnetic field of the strength for the mark to be formed can be applied to the magnetic recording layer. According to the present magnetic recording method as well, it is possible to appropriately form a recording mark while suppressing the recording demagnetization phenomenon and unsuitable enlargement of the recording mark. This thermally-assisted magnetic recording method is suitable for increased recording density of magnetic recording mediums.

According to the third aspect of the present invention, another method of recording information on a magnetic recording medium including a magnetic recording layer is provided. With this method, a local region in the recording layer is irradiated with a laser beam so that it is heated. Then, a recording magnetic field is applied to the heated local region to form a recording mark in the recording layer. The laser beam is adjusted in power in accordance with the length of the recording mark to be formed in the recording layer. The adjusted laser beam is irradiated to the local region in the recording layer.

As described above, when the time for which the recording magnetic field is applied (recording time) to the magnetic recording layer by the magnetic head differs, the effective magnetic coercive force at the location of application of the magnetic field differs, and furthermore, the shorter the recording time the greater the magnetic coercive force. On the other hand, the magnetic coercive force of the magnetic recording layer changes with this temperature, and the higher the temperature the weaker the magnetic coercive force. With the magnetic recording method of the third aspect of the present invention, when laser power is selected according to the length of the recording mark to be formed (in other words, according to recording time) when information is recorded on the magnetic recording medium, a magnetic field of the prescribed strength for the mark to be formed can be applied to the magnetic recording layer. Variation in information recording time is a causal factor in change in the magnetic coercive force at the location of application of the magnetic field on the magnetic recording layer. In practice, however, the magnetic coercive force at the location of application of the magnetic field may be maintained at a constant value by adjusting the temperature of the heated area by selecting laser power. By maintaining the magnetic coercive force at the location of application of the magnetic field at a constant value, the recording magnetic field of constant strength applied to the magnetic recording layer may be set equal to or greater than the effective magnetic coercive force at the location of application at the location of application of the magnetic field, and to a strength such that the afore-mentioned recording demagnetization phenomenon and unsuitable increase in width of the recording mark are sufficiently suppressed. According to the present magnetic recording method, therefore, each recording mark can be appropriately formed while suppressing the recording demagnetization phenomenon and unsuitable enlargement of the recording mark. Such a magnetic recording method is suitable for increased recording density of magnetic recording mediums.

In the third aspect of the present invention, it is desirable that the strength of the recording magnetic field is adjusted in strength in accordance with the length of the recording mark to be formed in the recording layer. The adjusted recording magnetic field is applied to the heated local region.

### BRIEF DESCRIPTION OF THE DRAWINGS

FIG. 1 is a graph showing the dependence of magnetic coercive force on recording time;

FIG. 2 shows a magnetic disk and slider for implementing a magnetic recording method according to a first embodiment of the present invention;

FIG. 3 is a table illustrating the relationship between recording mark (signal type), recording mark length, and recording magnetic field, set in the first embodiment;

FIG. 4 is a graph showing distribution of the magnetic coercive force and distribution of the recording magnetic field strength in the recording layer in the direction across the tracks in the first embodiment;

FIG. 5 shows a magnetic disk and slider for implementing a magnetic recording method according to a second embodiment of the present invention;

FIG. 6 is a table illustrating the relationship between recording mark (signal type), recording mark length, and recording magnetic field, set in the second embodiment.

FIG. 7 is a graph showing distribution of the magnetic coercive force and distribution of the recording magnetic field strength in the recording layer in the direction across the tracks in the second embodiment;

FIG. 8 shows a magnetic disk and slider for implementing a magnetic recording method according to a third embodiment of the present invention;

FIG. 9 is a table illustrating the relationship between recording mark (signal type), recording mark length, and laser power, set in the third embodiment; and

FIG. 10 is a graph showing the dependence of magnetic coercive force on recording time at differing temperatures.

### DETAILED DESCRIPTION OF THE PREFERRED EMBODIMENTS

The preferred embodiments of the present invention will now be described with reference to the accompanying drawings.

FIG. 2 shows a magnetic disk 10 and slider 20 for implementing a magnetic recording method according to a first embodiment of the present invention.

The magnetic disk 10 has a laminated structure comprising a disk substrate 11, a recording layer 12, and a protective layer 13, and is used for recording and playing back information. The disk substrate 11 primarily provides a stiffness of the magnetic disk 10, and is made for example of an aluminum alloy, glass, or synthetic resin. The recording layer 12 comprises a vertically magnetizable film or a horizontally magnetizable film to provide a recording surface for recording information on the magnetic disk 10. This recording surface comprises a plurality of concentric magnetic tracks. The recording layer 12 is made for example of Co alloy, Fe alloy, or rare-earth transition amorphous alloy. The protective layer 13 physically and chemically protects the recording layer 12 from external factors, and comprises, for example, SiN, SiO₂, or diamond-like carbon. The magnetic disk 10 may also include other layers as necessary. This magnetic disk 10 is supported by a spindle motor (not shown), and the spindle motor is rotatably driven in the direction D.

The slider 20 includes a slider body 21, a magnetic recording head 22 and a magnetic playback head 23, and floats in facing relationship to the magnetic disk 10 during recording and playback of information. The slider body 21 has a prescribed shape to create a gaseous lubrication film between the magnetic disk 10 and the slider 20 when the linear speed of the rotating magnetic disk 10 exceeds a prescribed value at the location opposite to the slider 20. The magnetic recording head 22 applies a prescribed recording magnetic field Hr to the recording layer 12. The magnetic recording head 22 comprises a coil in which a current flows to generate a magnetic field, and a magnetic pole for strengthening the generated magnetic field. The magnetic playback head 23 detects the magnetic signal derived from the magnetized condition of the recording layer 12 for converting it to an electrical signal. The magnetic playback head 23 comprises, for example, a GMR device or MR device. The slider 20 is linked to an actuator (not shown) via a leaf spring suspension arm (not shown). The actuator comprises, for example, a voice coil motor. The suspension arm acts to apply a force to the slider 20 towards the magnetic disk 10.

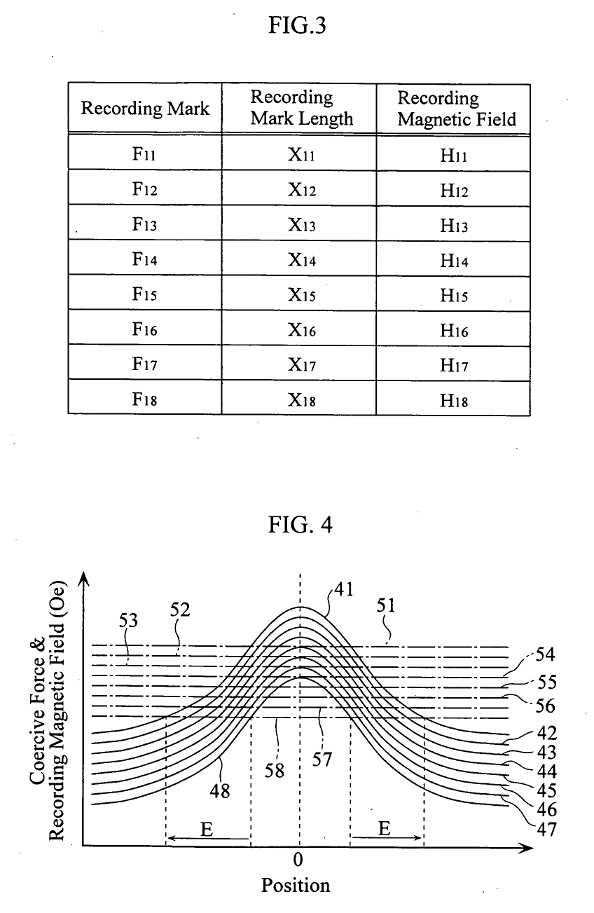

As shown in FIG. 3, a plurality of recording marks F11 through F18 are used as different kinds of signals in recording information according to the magnetic recording method of the present embodiment. The lengths X₁₁ through X₁₈ of the recording marks F₁₁ through F₁₈ are mutually different, having the relationship X₁₁<X₁₂<X₁₃<X₁₄<X₁₅<X₁₆<X₁₇<X₁₈. For example, X₁₁ is 36 nm, X₁₂ is 73 nm, X₁₃ is 109 nm, X₁₄ is 145 nm, X₁₅ is 181 nm, X₁₆ is 218 nm, X₁₇ is 245 nm, and X₁₈ is 290 nm. Furthermore, with this method, as shown in FIG. 3, the recording magnetic fields H₁₁ through H₁₈ are set as usable levels of recording magnetic fields Hr for the recording marks F₁₁ through F₁₈ depending on the radial position of the magnetic disk 10 at which the information is recorded (at which the recording mark is formed). The recording magnetic field strengths H₁₁, through H₁₈ have the relationship H₁₁≧H₁₂≧H₁₃≧H₁₄≧H₁₅≧H₁₆≧H₁₇≧H₁₈, and H₁₁≠H₁₈.

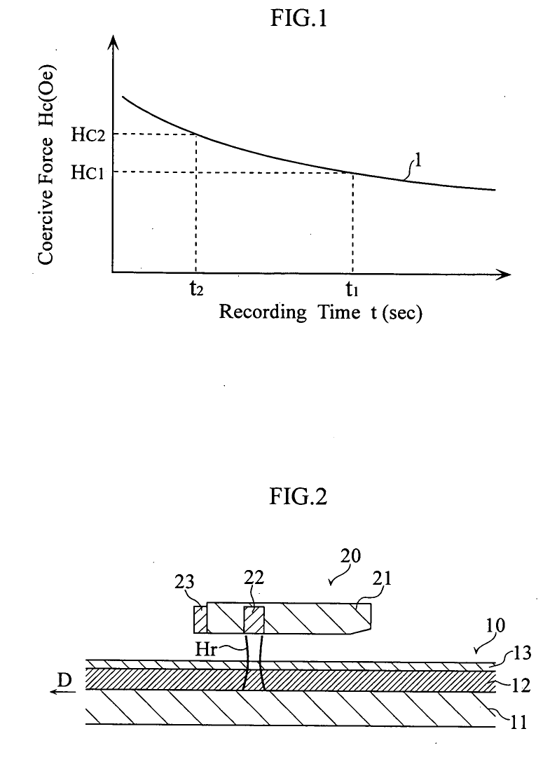

When the recording marks F₁₁ through F₁₈ are formed on the prescribed track while the magnetic disk 10 is rotated at a constant speed of rotation, the longer the recording mark the greater the tendency for the duration of application of the recording magnetic field Hr applied to the recording layer 12 (magnetic recording layer) employed in forming the recording mark (recording time to form a single recording mark) to increase. As described above with reference to FIG. 1, the shorter the recording time, the greater the effective magnetic coercive force in the magnetic recording layer, and the stronger the minimum external magnetic field able to form the recording mark on the magnetic recording layer. With this method, according to the lengths X₁₁ through X₁₈ of the recording marks F₁₁ through F₁₈ to be formed (in other words, according to recording time), a suitable strength of recording magnetic fields H₁₁ through H₁₈ equal to or greater than the effective magnetic coercive force at the location of application on the magnetic recording layer, and such that the afore-mentioned recording demagnetization phenomenon and unsuitable increase in width of the recording mark are sufficiently suppressed, is set as the recording magnetic field Hr. The suitable strength of recording magnetic fields H₁₁, through H₁₈ tends to decrease from the recording magnetic field H₁₁ to the recording magnetic field H₁₈, and is pre-determined with the prescribed trials (experimental recording and playback to determine optimum conditions for strength of recording magnetic field) for each recording mark F₁₁ through F₁₈ at the prescribed position on the disk radius.

When recording information on the magnetic disk 10, the magnetic disk 10 is rotated at the prescribed constant speed. Thus, a gaseous lubrication film is generated between the magnetic disk 10 and the slider 20, and the slider 20 is positioned floating above the magnetic disk 10. Furthermore, positioning of the slider 20 at the prescribed position on the radius of the disk is controlled by drive from the actuator. The recording magnetic field Hr is then applied to the recording layer 12 by the magnetic head 22 mounted on the slider 20. At this time, the recording magnetic field Hr being one of the recording magnetic fields H₁₁ through H₁₈ is selectively applied according to the recording mark F₁₁ through F₁₈ to be formed in the recording layer 12 at the disk radius, and its length X₁₁ through X₁₈. Furthermore, by sequentially reversing the orientation of the recording magnetic field Hr from the magnetic head 22 while rotating the magnetic disk 10, a plurality of magnetic domains (recording marks F₁₁ through F₁₈) wherein the orientation of magnetization in the recording layer 12 is sequentially reversed are formed joined from the circumferential direction of the magnetic disk 10 towards the direction of extension of the tracks. At this time, the recording marks F₁₁ through F₁₈ are formed to the respective prescribed lengths X₁₁ through X₁₈ by controlling the timing with which the orientation of the recording magnetic field is reversed. In this manner, the prescribed signals and information are recorded in the recording layer 12 as changes in the magnetic orientation.

In the magnetic recording method of the present embodiment, according to the lengths X₁₁ through X₁₈ of the recording marks F₁₁ through F₁₈ to be formed (in other words, according to recording time), a suitable strength of recording magnetic field equal to or greater than the effective magnetic coercive force at the location of application on the magnetic recording layer 12, and such that the recording demagnetization phenomenon and unsuitable increase in width of the recording mark are sufficiently suppressed, is selected, and the recording magnetic field Hr of a strength for the recording mark to be formed can be applied to the recording layer 12, when recording information on the magnetic disk 10. According to the present magnetic recording method, therefore, the appropriate recording marks F₁₁ through F₁₈ can be formed while the recording demagnetization phenomenon and unsuitable increase in width of the recording mark is suppressed. Such a magnetic recording method is suitable for increased recording density of magnetic recording mediums.

FIG. 4 is a graph showing an example of distribution of the magnetic coercive force and distribution of the recording magnetic field strength in the recording layer 12 when information is recorded as described above. In the graph in FIG. 4, the position in the direction across the tracks is shown on the horizontal axis (the position corresponding to the center in the width direction of the magnetic head 22 as 0), the magnetic coercive force and the recording magnetic field strength (Oe) in the recording layer 12 is shown on the vertical axis, the strength distribution in the recording layer 12 of the recording magnetic fields H₁₁ through H₁₈ applied to the recording layer 12 when the recording marks F₁₁ through F₁₈ are formed are shown as the solid lines 41 through 48 (the strengths of the recording magnetic fields H₁₁ through H₁₈ all differ in this example), and the distribution of the magnetic coercive force in the recording layer 12 when the recording marks F₁₁ through F₁₈ are formed are shown as the dashed lines 51 through 58.

In the example in FIG. 4, the recording marks F₁₁ through F₁₈ for which the unsuitable increase in width of the recording mark is suppressed are formed by selectively applying the recording magnetic fields H₁₁ through H₁₈ set to the mutually differing strengths for the recording marks F₁₁ through F₁₈ to the recording marks F₁₁ through F₁₈ (and the lengths X₁₁ through X₁₈) to be formed. Conventionally, if the recording magnetic field H₁₁ is assumed to be applied to the recording layer 12 when the recording mark F₁₈ set for the recording magnetic field H₁₈ is formed, as shown by the arrow E, a recording mark F₁₈ for which the width is enlarged beyond that of the conventional recording mark F₁₈ is formed. According to the present magnetic recording method, enlargement of the width of such a recording mark can be suppressed.

The magnetic disk 10 is rotated at the prescribed speed during playback of the information on the magnetic disk 10. Thus, a gaseous lubrication film is generated between the magnetic disk 10 and the slider 20, and the slider 20 is positioned floating above the magnetic disk 10. In this condition, the signal magnetic field derived from the recording marks F₁₁ through F₁₈ in the recording layer 12 is detected with the magnetic head 23 mounted on the slider 20. Thus, the information on the magnetic disk 10 can be played back.

FIG. 5 shows the magnetic disk 10′ and slider 30 for executing the thermally-assisted magnetic recording method of the second embodiment of the present invention.

The magnetic disk 10′ has a laminated structure comprising a disk substrate 11, a recording layer 12, and a protective layer 13, and comprises a magnetic recording medium wherein information may be recorded and played back. The practical configuration of the disk substrate 11, recording layer 12, and protective layer 13, and the magnetic disk 10′ drive mechanism, are the same as in the afore-mentioned first embodiment.

The slider 30 is provided with a slider body 31, a focusing lens 32, a magnetic head 33 for recording, and a playback magnetic head 34, and positioned opposite the magnetic disk 10′ during recording and playback of information. The slider body 31 is of the prescribed shape to create a gaseous lubrication film between the magnetic disk 10′ and protective layer 13, and the slider 30 when the linear speed on the magnetic disk 10′ of the location opposite to the slider 30 during rotation exceeds the prescribed value. Furthermore, the slider body 31 has a prescribed laser illuminator 31a on the side opposite to the medium, and is configured such that the laser light L emitted from the light source (not shown in figures) and passed through the focusing lens 32 may be radiated from the laser illuminator 31a. The focusing lens 32 focuses the laser light L. The magnetic head 33 applies the prescribed recording magnetic field Hr to the recording layer 12, and comprises a coil in which a current flows to generate a magnetic field, and a magnetic pole to convert the generated magnetic field into a strong magnetic field. The magnetic head 34 detects the magnetic signal derived from the magnetized condition of the recording layer 12, and converts it to an electrical signal, and comprises, for example, a GMR device or MR device. Such a slider 30 is linked to an actuator (not shown in figures) via a sheet-spring suspension arm (not shown in figures). The actuator comprises, for example, a voice coil motor. The suspension arm acts to apply a force to the slider 30 towards the magnetic disk 10′.

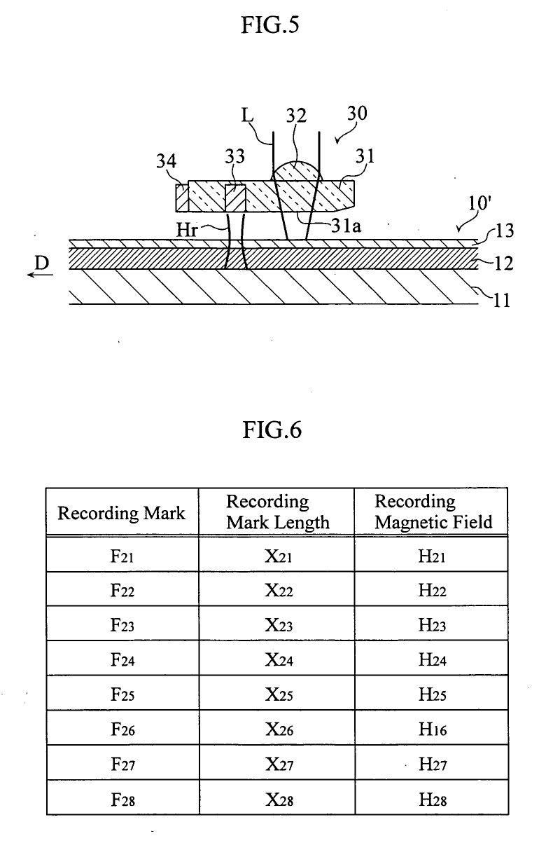

As shown in FIG. 6, a plurality of recording marks F₂₁ through F₂₈ are set as the types of signals employed in recording information in the thermally-assisted magnetic recording method of the present embodiment. The lengths X₂₁ through X₂₈ of recording marks F₂₁ through F₂₈ are mutually different, having the relationship X₂₁<X₂₂<X₂₃<X₂₄<X₂₅<X₂₆<X₂₇<X₂₈. Furthermore, with this method, as shown in FIG. 6, the recording magnetic fields H₂₁ through H₂₈ are set as the recording magnetic field Hr for the recording marks F₂₁ through F₂₈ according to the position on the disk radius of the location (location at which the recording mark is formed) at which the information is recorded on the magnetic disk 10′. The recording magnetic field strengths H₂₁ through H₂₈ have the relationship H₂₁≧H₂₂≧H₂₃≧H₂₄≧H₂₅≧H₂₆≧H₂₇≧H₂₈, and H₂₁≠H₂₈.

When the recording marks F₂₁ through F₂₈ are formed on the prescribed track while the magnetic disk 10′ is rotated at a constant speed of rotation, the longer the recording mark the greater the tendency for the duration of application of the recording magnetic field Hr applied to the recording layer 12 (magnetic recording layer) employed in forming the recording mark (recording time to form a single recording mark) to increase. As described above with reference to FIG. 1, the shorter the recording time, the greater the effective magnetic coercive force in the magnetic recording layer, and the stronger the minimum external magnetic field able to form the recording mark on the magnetic recording layer. With this method, according to the lengths X₂₁ through X₂₈ of the recording marks F₂₁ through F₂₈ to be formed (in other words, according to recording time), a suitable strength of recording magnetic fields H₂₁ through H₂₈ equal to or greater than the effective magnetic coercive force at the location of application of the magnetic field within the locally heated area in the recording layer 12, and such that the afore-mentioned recording demagnetization phenomenon and unsuitable increase in width of the recording mark are sufficiently suppressed is set as the recording magnetic field Hr. The suitable strength of recording magnetic fields H₂₁ through H₂₈ tends to decrease from the recording magnetic field H₂₁ to the recording magnetic field H₂₈, and is pre-determined with the prescribed trials (experimental recording and playback to determine the optimum conditions for strength of recording magnetic field) for each recording mark F₂₁ through F₂₈ at the prescribed position on the disk radius.

When recording information with the thermally-assisted magnetic recording method of the present embodiment, the magnetic disk 10′ is rotated at the prescribed constant speed. Thus, a gaseous lubrication film is generated between the magnetic disk 10′ and the slider 30, and the slider 30 is positioned floating above the magnetic disk 10′. Furthermore, positioning of the slider 30 at the prescribed position on the radius of the disk is controlled by drive from the actuator. The recording surface of the magnetic disk 10′ (recording layer 12) is then continuously illuminated with laser light L emitted from the laser illuminator 31a and passing through the focusing lens 31 mounted on the slider 30. In the present embodiment, the laser light L output (laser power) is maintained at a constant value, and the extent of weakening of the magnetic coercive force of the recording layer 12 due to the laser illumination set to a constant value irrespective of the recording marks F₂₁ through F₂₈ to be formed. Additionally, in the present method, the recording magnetic field Hr is applied to the heated area in the recording layer 12 by laser illumination using the magnetic head 33 mounted on the slider 30. At this time, the recording magnetic field Hr being one of the recording magnetic fields H₂₁ through H₂₈ is selectively applied according to the recording mark F₂₁ through F₂₈ to be formed in the recording layer 12 and its length X₂₁ through X₂₈. Furthermore, by sequentially reversing the orientation of the recording magnetic field Hr from the magnetic head 33 while rotating the magnetic disk 10′, a plurality of magnetic domains (recording marks F₂₁ through F₂₈) wherein the direction of magnetization in the recording layer 12 is sequentially reversed are formed joined from the circumferential direction of the magnetic disk 10′ towards the direction of extension of the tracks. At this time, the recording marks F₂₁ through F₂₈ are formed to the respective prescribed lengths X₂₁ through X₂₈ by controlling the timing with which the orientation of the recording magnetic field is reversed. In this manner, the prescribed signals and information are recorded in the recording layer 12 as changes in the magnetic orientation.

In the thermally-assisted magnetic recording method of the present embodiment, according to the lengths X₂₁ through X₂₈ of the recording marks F₂₁ through F₂₈ to be formed (in other words, according to recording time), a suitable strength of recording magnetic field equal to or greater than the effective magnetic coercive force at the location of application on the magnetic recording layer 12, and such that the recording demagnetization phenomenon and unsuitable increase in width of the recording mark are sufficiently suppressed, is selected, and the recording magnetic field Hr of a strength for the recording mark to be formed can be applied to the recording layer 12, when recording information on the magnetic disk 10′. According to the present magnetic recording method, therefore, the appropriate recording marks F₂₁ through F₂₈ can be formed while the recording demagnetization phenomenon and unsuitable increase in width of the recording mark is suppressed. Such a magnetic recording method is suitable for increased recording density of magnetic recording mediums.

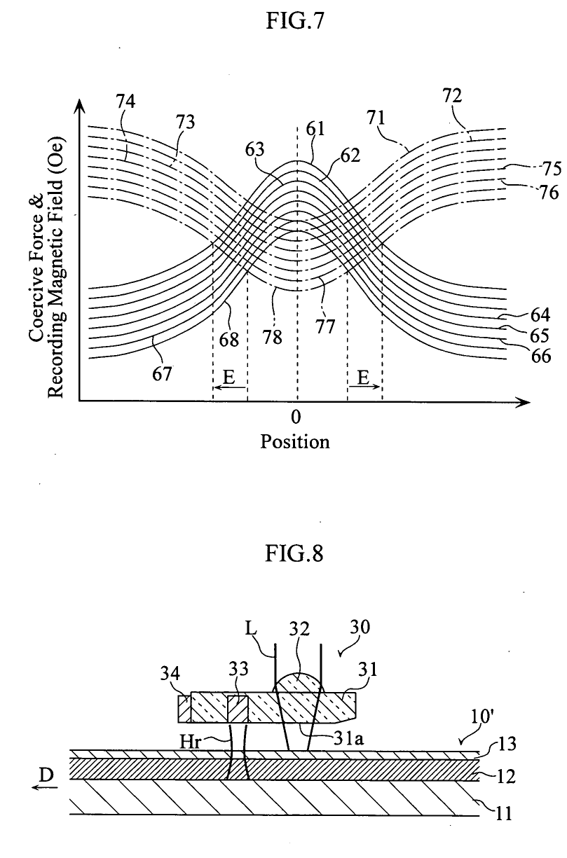

FIG. 7 is a graph showing an example of distribution of the magnetic coercive force and distribution of the recording magnetic field strength in the recording layer 12 when information is recorded as described above. In the graph in FIG. 7, the position in the direction across the tracks is shown on the horizontal axis (the position corresponding to the center in the width direction of the magnetic head 33 as 0), the magnetic coercive force and the recording magnetic field strength (Oe) in the recording layer 12 is shown on the vertical axis, the strength distribution in the recording layer 12 of the recording magnetic fields H₂₁ through H₂₈ applied to the recording layer 12 when the recording marks F₂₁ through F₂₈ are formed are shown as the solid lines 61 through 68 (the strengths of the recording magnetic fields H₂₁ through H₂₈ all differ in this example), and the distribution of the magnetic coercive force in the recording layer 12 when the recording marks F₂₁ through F₂₈ are formed are shown as the dashed lines 71 through 78 (the magnetic coercive force in the recording layer 12 is locally reduced by local heating of the recording layer 12 by laser).

In the example in FIG. 7, the recording marks F₂₁ through F₂₈ for which the unsuitable increase in width of the recording mark is suppressed are formed by selectively applying the recording magnetic fields H₂₁ through H₂₈ set to the mutually differing strengths for the recording marks F₂₁ through F₂₈ to the recording marks F₂₁ through F₂₈ (and the lengths X₂₁ through X₂₈) to be formed. Conventionally, if the recording magnetic field H₂₁ is assumed to be applied to the recording layer 12 when the recording mark F₂₈ set for the recording magnetic field H₂₈ is formed, as shown by the arrow E, a recording mark F₂₈ for which the width is enlarged beyond that of the conventional recording mark F₂₈ is formed. According to the present magnetic recording method, enlargement of the width of such a recording mark can be suppressed.

By rotating the magnetic disk 10′ at the prescribed speed during playback of the information on the magnetic disk 10′, the signal magnetic field derived from the recording marks F₂₁ through F₂₈ in the recording layer 12 is detected with the magnetic head 34 mounted on the slider 30 while the slider 30 is positioned floating above the magnetic disk 10′. Thus, the information on the magnetic disk 10′ can be played back.

FIG. 8 shows the magnetic disk 10′ and slider 30 for executing the thermally-assisted magnetic recording method of the third embodiment of the present invention. The magnetic disk 10′ and slider 30 are the same as in the afore-mentioned second embodiment.

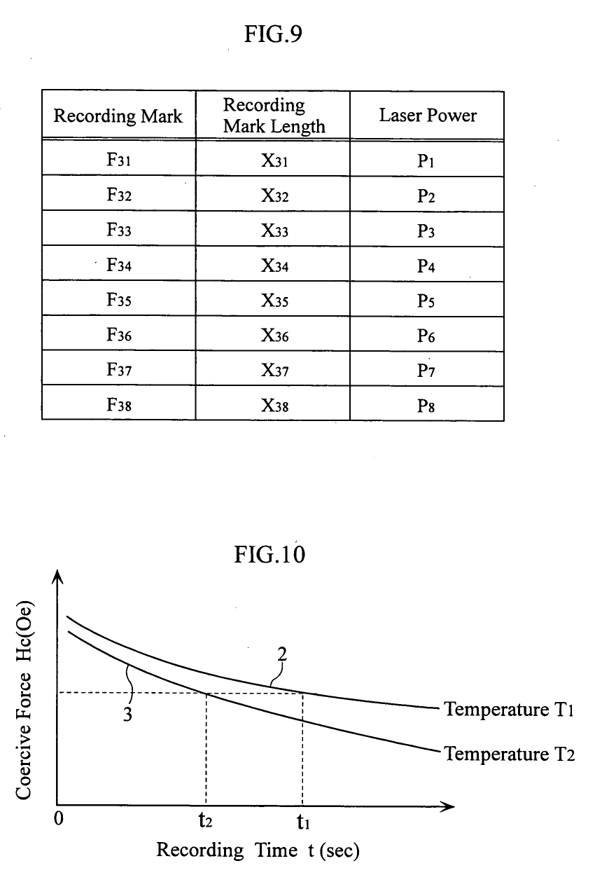

As shown in FIG. 9, a plurality of recording marks F₃₁ through F₃₈ are set as the types of signals employed in recording information in the thermally-assisted magnetic recording method of the present embodiment. The lengths X₃₁ through X₃₈ of recording marks F₃₁ through F₃₈ are mutually different, having the relationship X₃₁<X₃₂<X₃₃<X₃₄<X₃₅<X₃₆<X₃₇<X₃₈. Furthermore, with this method, as shown in FIG. 9, the laser power P₁ through P₈ of the laser light L is set for the recording marks F₃₁ through F₃₈ according to the position on the disk radius of the location (location at which the recording mark is formed) at which the information is recorded on the magnetic disk 10′. The laser power P₁ through P₈ has the relationship P₁≧P₂≧P₃≧P₄≧P₅≧P₆≧P₇≧P₈, and P₁≠P₈.

In the technical field of magnetic disks, it is known that the magnetic coercive force of the magnetic recording layer changes with temperature, and that the higher the temperature the weaker the magnetic coercive force. FIG. 10 is a graph showing an example of the dependence of magnetic coercive force on recording time according to the afore-mentioned equation (1) at the differing temperatures T₁ and T₂. In the graph in FIG. 10, the recording time t (seconds) is displayed on the horizontal axis, and the magnetic coercive force Hc (Oe) of the magnetic recording layer is displayed on the vertical axis, and the solid lines 2 and 3 represent the dependence of the magnetic coercive force Hc on recording time at the differing temperatures T₁ and T₂. As shown in the graph in FIG. 10, at the same temperature if the time for which the external magnetic field is applied to the magnetic recording layer by a magnetic head (recording time t) differs, the effective magnetic coercive force Hc at the location of application of the magnetic field differs, and the shorter the recording time t, the greater the magnetic coercive force Hc. Furthermore, according to the graph in FIG. 10, even if the recording time t differs, it is apparent that if temperature differs, it is possible to obtain a matching effective magnetic coercive force Hc at the location of application of the magnetic field. For example, the magnetic coercive force Hc when the recording time t is the prescribed t₁ at the temperature T₁, is the same as the magnetic coercive force Hc when the recording time t is the prescribed t₂ at the temperature T₂.

When the recording marks F₃₁ through F₃₈ are formed on the prescribed track while the magnetic disk 10′ is rotated at a constant speed of rotation, the longer the recording mark the greater the tendency for the duration of application of the recording magnetic field Hr applied to the recording layer 12 (magnetic recording layer) employed in forming the recording mark (recording time to form a single recording mark) to increase. As described above with reference to FIG. 1, the shorter the recording time, the greater the tendency for the effective magnetic coercive force in the magnetic recording layer to increase, and as described above in reference to FIG. 10, the higher the temperature of the magnetic recording layer the weaker the magnetic coercive force. With this method, according to the lengths X₃₁ through X₃₈ of the recording marks F₃₁ through F₃₈ to be formed (in other words, according to recording time), the suitable laser power P₁ through P₈ is set such that the recording magnetic field Hr maintained at a fixed strength is equal to or greater than the effective magnetic coercive force at the location of application of the magnetic field within the locally heated area in the recording layer 12, and the recording demagnetization phenomenon and unsuitable increase in width of the recording mark are sufficiently suppressed. The suitable laser power P₁ through P₈ tends to decrease from P₁ to P₈, and is pre-determined with the prescribed trials (experimental recording and playback to determine the optimum conditions for laser power) for each recording mark F₃₁ through F₃₈ at the prescribed position on the disk radius.

When recording information with the thermally-assisted magnetic recording method of the present embodiment, the magnetic disk 10′ is rotated at the prescribed constant speed. Thus, a gaseous lubrication film is generated between the magnetic disk 10′ and the slider 30, and the slider 30 is positioned floating above the magnetic disk 10′. Furthermore, positioning of the slider 30 at the prescribed position on the radius of the disk is controlled by drive from the actuator. The recording surface of the magnetic disk 10′ (recording layer 12) is then continuously illuminated with laser light L emitted from the laser illuminator 31a and passing through the focusing lens 31 mounted on the slider 30. In the present embodiment, the laser power P₁ through P₈ is selected according to the recording marks F₃₁ through F₃₈ to be formed, the extent of heating of the recording layer 12 by laser illumination (and thus the weakening of the magnetic coercive force) changes according to the recording marks F₃₁ through F₃₈ to be formed. Additionally, in the present method, the recording magnetic field Hr of constant strength is applied to the heated area in the recording layer 12 using the magnetic head 33 mounted on the slider 30. Furthermore, by sequentially reversing the orientation of the recording magnetic field from the magnetic head 33 while rotating the magnetic disk 10′, a plurality of magnetic domains (recording marks F₃₁ through F₃₈) wherein the direction of magnetization in the recording layer 12 is sequentially reversed are formed joined from the circumferential direction of the magnetic disk 10′ towards the direction of extension of the tracks. At this time, the recording marks F₃₁ through F₃₈ are formed to the respective prescribed lengths X₃₁ through X₃₈ by controlling the timing with which the orientation of the recording magnetic field is reversed. In this manner, the prescribed signals and information are recorded in the recording layer 12 as changes in the magnetic orientation.

In the thermally-assisted magnetic recording method of the present embodiment, a suitable laser power P₁ through P₈ is selected according to the lengths X₃₁ through X₃₈ of the recording marks F₃₁ through F₃₈ to be formed (in other words, according to recording time), and the magnetic coercive force of the laser illuminated area on the recording layer 12 maintained at a constant value, and thus a recording magnetic field Hr of constant strength can be applied to the recording layer 12. Variation in information recording time when recording information is a causal factor in change in the magnetic coercive force at the location of application of the magnetic field in the recording layer 12. In practice, however, the magnetic coercive force at the location of application of the magnetic field may be maintained at a constant value by adjusting the temperature of the heated area by selecting laser power. According to the present magnetic recording method, therefore, the appropriate recording marks F₃₁ through F₃₈ can be formed while the recording demagnetization phenomenon and unsuitable increase in width of the recording mark is suppressed. Such a magnetic recording method is suitable for increased recording density of magnetic recording mediums.

The method of playback for information on the magnetic disk 10′ in the present embodiment is the same as described above in the second embodiment.

In the afore-mentioned first through third embodiments of the magnetic recording method, relative adjustment of the magnetic coercive force at the location of the recording mark to be formed in the recording layer 12, and the strength of the recording magnetic field Hr applied at the location of the recording mark to be formed, is achieved by selecting the recording magnetic field Hr or laser power according to the length of the recording mark. In place of this method, the present invention pre-sets both the suitable recording magnetic field Hr and the suitable laser power for each recording mark length, and relative adjustment of the magnetic coercive force and strength of the applied recording magnetic field at the location at which the recording mark is to be formed in the recording layer 12 may be achieved by selecting both recording magnetic field Hr and the laser power according to the length of the recording mark.

1. A magnetic recording method for a magnetic recording medium including a magnetic recording layer, the method comprising the steps of:
applying a recording magnetic field to a local region in the recording layer to form a recording mark in the recording layer; and
applying a recording magnetic field to another local region in the recording layer to form another recording mark in the recording layer;
wherein each of the recording magnetic fields is adjusted in strength in accordance with a length of the recording mark to be formed in the recording layer, the adjusted recording magnetic field being applied locally to the recording layer.

2. A magnetic recording method for a magnetic recording medium including a magnetic recording layer, the method comprising the steps of:
irradiating a local region in the recording layer with a laser beam to heat the local region; and
applying a recording magnetic field to the heated local region to form a recording mark in the recording layer;
wherein the recording magnetic field is adjusted in strength in accordance with a length of the recording mark to be formed in the recording layer, the adjusted recording magnetic field being applied to the heated local region.

3. A magnetic recording method for a magnetic recording medium including a magnetic recording layer, the method comprising the steps of:
irradiating a local region in the recording layer with a laser beam to heat the local region; and
applying a recording magnetic field to the heated local region to form a recording mark in the recording layer;
wherein the laser beam is adjusted in power in accordance with a length of the recoding mark to be formed in the recording layer, the adjusted laser beam being irradiated to the local region in the recording layer.

4. The magnetic recording method according to claim 3, wherein the recording magnetic field is adjusted in strength in accordance with the length of the recording mark to be formed in the recording layer, the adjusted recording magnetic field being applied to the heated local region.
